(19) United States
(12) Patent Application Publication
(10) Pub. No.: US 2002/0120650 A1
(43) Pub. Date: Aug. 29, 2002

(54) Technique to validate electronic books

(76) Inventor: Chris M. d'Aquin, Dickinson, TX (US)

Correspondence Address: Fred G. Pruner, Jr., TROP, PRUNER & HU, P.C., Ste. 100, 8554 Katy Freeway, Houston, TX, 77024, US

(21) Appl. No.: 09/793,365

(22) Filed: Feb. 26, 2001

(51) Int. Cl. G06F 17/21; G06F 17/24

(52) U.S. Cl. 707/513; 707/517

(57) ABSTRACT

A technique includes finding a tag in a markup language file and automatically locating a target of the tag. A determination is automatically made whether the tag is valid based on the target.

### BACKGROUND

The invention generally relates to a technique to validate an electronic book, such as a technique to generally assess the quality and accuracy of tags and files that are associated with the book, for example.

A document that is viewed on a computer and communicated over a global computer network typically is described in a markup language file. The markup language file indicates the structure, layout and links that are associated with the document. In this manner, a browser (Internet Explore® made by Microsoft®, for example) reads the markup language file and in response, displays images, text and links that are associated with the document. Hypertext Markup Language (HTML) and Extensible Markup Language (XML) are examples of different markup languages.

The markup language file typically includes tags that define the format of associated text and define external and internal links. In this manner, the tags may include such structural tags as paragraph tags and line break tags to govern the formatting of the associated text. The tags may include internal linking tags that define links to various parts of the document. For example, the markup language file may cause the browser to display a table of contents, and each line entry in the displayed table of contents may be tagged as a link to a particular page of the document. For example, by “clicking” a mouse pointer on “Chapter Four” in the displayed table of contents, the browser may display text from page 34 of the document, the page on which chapter four begins.

The tags may also include external linking tags. An external linking tag defines a link to files or documents that are external to the markup language file. One example of an external linking tag is an image tag, a tag that references (or “points to”) an image file that describes an image to be displayed by the browser.

The markup language file may contain other types of tags. For example, some tags of the document may indicate the subject matter of the associated tagged text. As an example, a particular tag may indicate that the associated text is the name of an author or a publisher of the work.

The markup language file may describe all or part of an electronic book that typically is based on a physical, non-electronic book. In this manner, when the browser reads the document, the browser may display the text and images that are associated with the electronic book. To create the markup language file from the physical book, typically the pages of the physical book are scanned so that a computer may use optical character recognition (OCR) software to create the ASCII codes that represent the text of the book. Thus, the scanning and the use of the OCR software create a digital text file.

For purposes of forming the markup language file from the digital text file, tags are inserted into the digital text file. The insertion of tags into the text document typically is a manually-driven process that is subject to human error. As a result of the extensive tagging that may be required, some of the tagging may be incorrect, and thus, the markup language file may not accurately describe the physical book.

Thus, there is a continuing need for an arrangement and/or technique to address one or more of the problems that are stated above.

### SUMMARY

In an embodiment of the invention, a technique includes finding a tag in a markup language file and automatically locating a target of the tag. A determination is automatically made whether the tag is valid based on the target.

In another embodiment of the invention, a technique includes finding linking tags in a markup language file. Each tag is associated with a target. The targets are automatically located, and the technique includes automatically selectively determining whether the tags are valid based on the targets.

In yet another embodiment of the invention, a technique includes providing a markup language file that is associated with an electronic book and image files that are associated with the book. The file is automatically scanned to find links between the markup language file and the image files. A determination is made whether tagging errors exist based on the scanning.

Advantages and other features of the invention will become apparent from the following drawing, description and claims.

### BRIEF DESCRIPTION OF THE DRAWING

FIG. 1 is a schematic diagram of a technique to form an electronic book according to an embodiment of the invention.

FIGS. 2 and 11 are schematic diagrams of computer systems according to embodiments of the invention.

FIG. 3 is a flow diagram depicting a technique to check the validity of an electronic book according to an embodiment of the invention.

FIG. 4 is an illustration of a linking information file according to an embodiment of the invention.

FIG. 5 is an illustration of the use of an external linking tag according to an embodiment of the invention.

FIG. 6 is an illustration of the use of an internal linking tag according to an embodiment of the invention.

FIGS. 7, 8, 9 and 10 are flow diagrams depicting a technique to check the validity of an electronic book according to an embodiment of the invention.

FIG. 12 is an illustration of a look-up table according to an embodiment of the invention.

### DETAILED DESCRIPTION

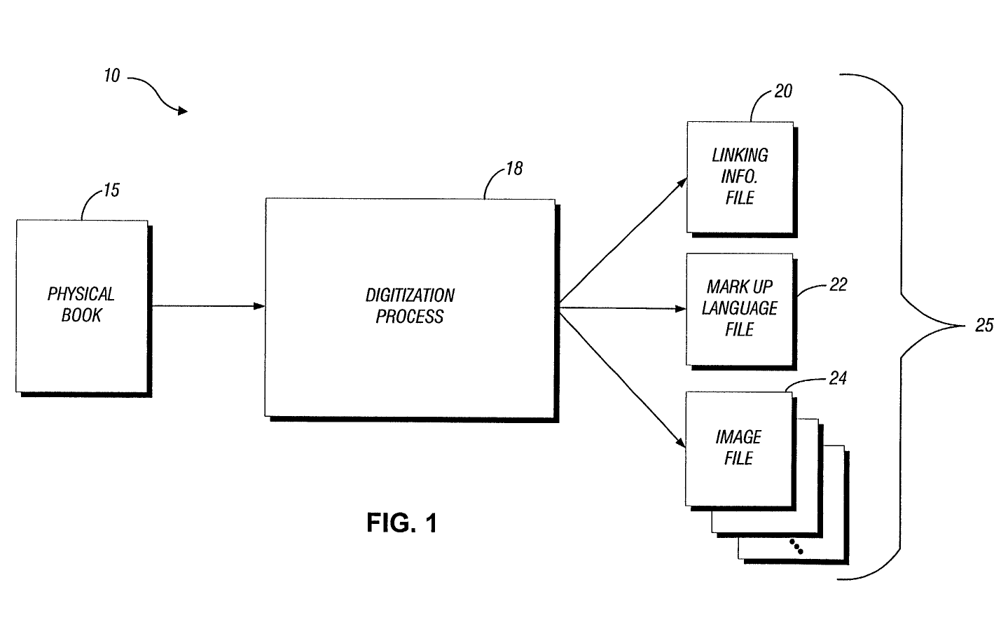

FIG. 1 depicts an embodiment 10 of a technique to “digitize” a physical book 15 to form computer readable files 25 that collectively form an electronic book, i.e., the electronic version of the physical book 15. In the embodiment 10, pages of the physical book 15 are scanned to start a digitization process 18, a process in which ASCII codes are created to indicate the text of the electronic book and image files 24 (part of the files 25) are created to indicate the various images (figures and pictures, for example) of the electronic book.

Besides forming the ASCII codes and image files 24, the digitization process 18 also includes the creation of tags that describe the layout, external and internal links, content, and other information associated with the electronic book. Thus, the digitization process 18 includes the creation of a markup language file 22 (part of the files 25), a file that includes the ASCII text of the electronic book, as well as the various tags that are associated with the electronic book. In some embodiments of the invention, the digitization process 18 also forms a linking information file 20 (part of the files 25), a file that indicates, as its name implies, information that is used in connection with the external and internal linking operations, as further described below.

In the context of this application, the phrase “markup language” generally refers to a language that includes tags to generally describe the format, content and/or links that are associated with text and/or image(s). Hypertext Markup Language (HTML) and Extensible Markup Language (XML) are examples of different markup languages that may be used in accordance with different embodiments of the invention. However, other markup languages may be used in other embodiments of the invention.

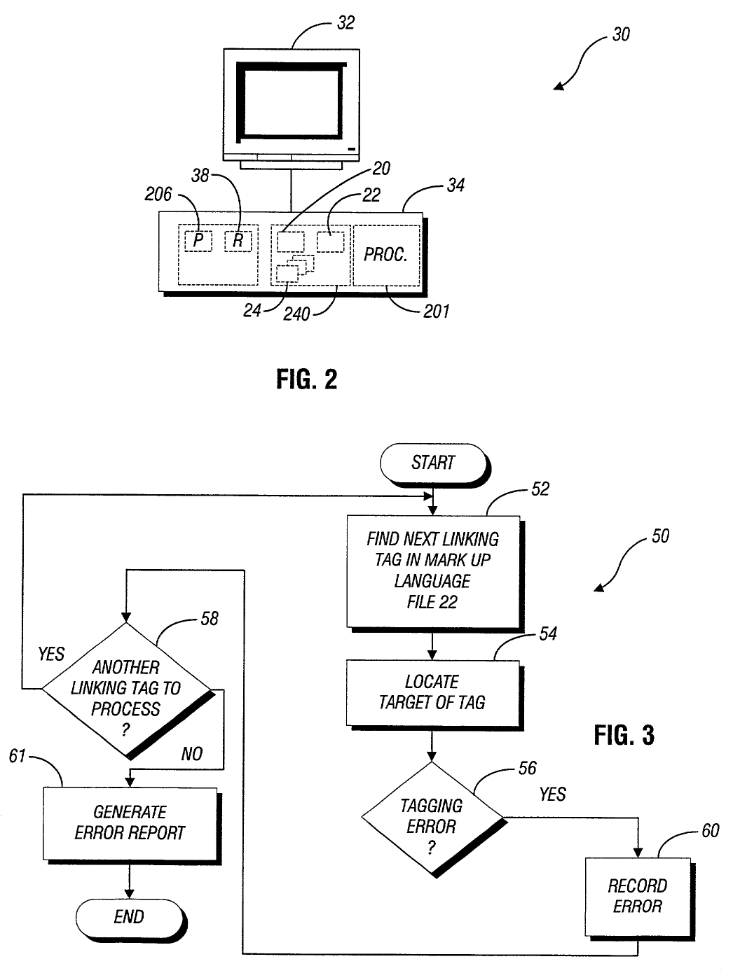

The insertion of the various tags to create the markup language file 22 and linking information file 20 typically is a manually-driven process that is subject to human error. However, referring to FIG. 2, a computer system 30 in accordance with the invention maybe used to find and record the error(s) in the electronic book.

More specifically, the computer system 30 includes a processor 201 that executes a program 36 (stored in a system memory 206, for example) to automatically locate errors in the electronic book. The computer system 30 stores copies of the files 25 in mass storage 240. The processor 201 records the errors, as processed, in an error report file 38 that is stored in the system memory 206, for example.

As an example of one type of error that is detected by the processor 201 when executing the program 36, the processor 201 may generally perform a technique 50 (see FIG. 3) to find errors associated with linking tags. In this manner, referring to FIG. 3, in the technique 50, the processor 201 performs an iterative process to locate and verify the validity of each linking tag. Thus, as long as all linking tags have not been processed, the processor 201 finds the next linking tag in the markup language file 22, as depicted in block 52, and locates (block 54) the target of this tag. If the processor 201 determines (diamond 56) that a tagging error has been detected (as described in more detail below), then the processor 201 records the error, as depicted in block 60. Otherwise, the processor 201 determines (diamond 58) if there is another linking tag to process, and if so, control returns to block 52. After all linking tags are processed, the processor 201 generates an error report (from the error record file 38), as depicted in block 61.

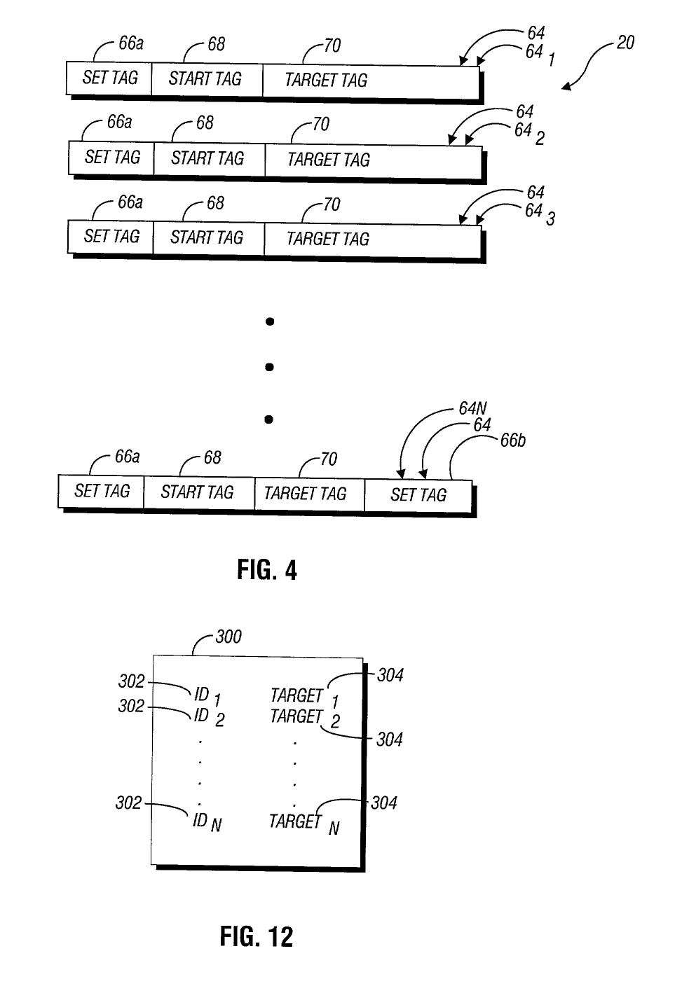

Each linking tag in the markup language file 22 has a target, and this target is indicated in the linking information file 20, in some embodiments of the invention. For example, FIG. 4 depicts an exemplary embodiment of the linking information file 20. As shown, the linking information file 20 includes tag subsets 64 (subsets 64₁, 64₂, . . . 64_{N}, depicted as examples), each of which is associated with an internal or external linking tag of the markup language file 22. In this manner, the beginning of a particular tag subset 64 is denoted by an opening set tag 66a, and the end of the tag subset 64 is denoted by a closing set tag 66b. Between the set tags 66a and 66b are a start tag 68 and a target tag 70. The start tag 68 indicates, for example, the page number on which a particular linking tag is located and the identifier of the tag, thereby identifying the starting point, or beginning, of the associated linking operation. The target tag 70 indicates the target address, or ending point of the linking operation. For example, if a particular linking tag is an image tag, then the target tag 70 should (if no error(s) are present) indicate a file name of an image file, thereby indicating the target of the linking operation. Similarly, if a particular linking tag is an external linking tag to a different electronic book, then the target tag 70 should (if no error(s) are present) indicate a particular target electronic book or a particular page within a particular electronic book As another example, if a particular linking tag is an internal linking tag, then the target tag 70 should (if no error(s) are present) indicate a particular page number of the document that is described by the markup language file 22, thereby indicating the target of the linking operation, which in this case, is the ending point of the linking operation.

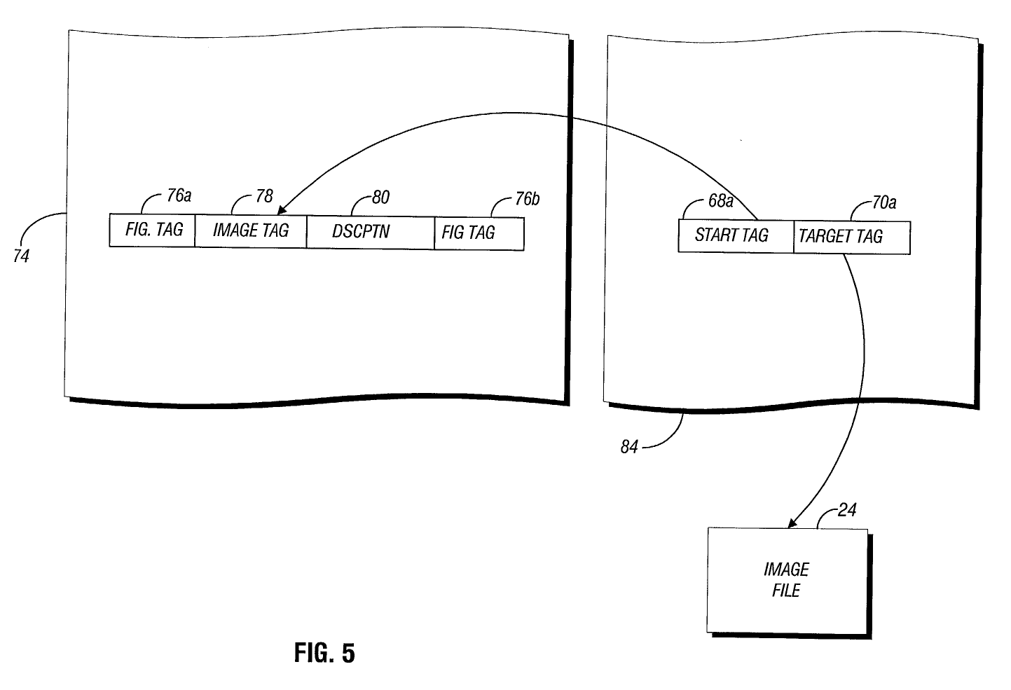

FIG. 5 illustrates the use of external linking tags with the linking information file 20. Depicted in FIG. 5 is a portion 74 of the markup language file 22, a portion 74 that includes opening 76a and closing 76b figure tags that, as their names imply, indicate the insertion of a figure for the displayed document. An image tag 78 (an external linking tag) is located between the figure tags 76a and 76b. As its name implies, the image tag 78 indicates the insertion of an image into the displayed document. Located between the image tag 78 and the closing figure tag 76b is a textual description 80 of the figure. For example, if the image is an image of a house, then the description 80 may include the ASCII characters that indicate the word “HOUSE.”

Inside the markup language file 22, the image tag 78 has a unique identification, or “ID,” that may be indicated by one or more alphanumeric identifiers. For example, the image tag 78 may appear as the following inside the markup language file 22: “<image id=“xxx184”/>”. The character “<” indicates the beginning of the image tag 78, the characters “image” indicate that this is an image tag, the characters “xxx” indicate an external linking tag, and the characters “id=“xxx184”” indicate that the ID for the image tag 78 is “184.” Therefore, any reference to the identifier “xxx184” in the linking information file 20 refers to the image tag 78.

Also depicted in FIG. 5 is a corresponding portion 84 of the linking information file 20, a portion which contains a start tag 68a and a target tag 70a. The start tag 68a identifies the image tag 78. For the example given above, the start tag 68a may indicate the page number (of the markup language document 22) on which the image tag 78 is located as well as the ID (“x184,” for this example) of the image tag 78. The target tag 70a indicates the file name of the image file 24 to be inserted into the position indicated by the location of the image tag 78 in the markup language file 22. Thus, to complete this example, if the image tag 78 is located on page 7 of the document that is described by the markup language file 22, then the start tag 68a may appear as the following: “<start xlink:href=”pg7#xxx184“/>.” The characters “start” indicate that this is a start tag, the characters “xxx” between “#” and “184” indicate that the start tag 68a is associated with an external linking tag, the characters “pg7” indicate the page number of the image tag 78, and the characters “184” indicate the external linking tag ID of the image tag 78.

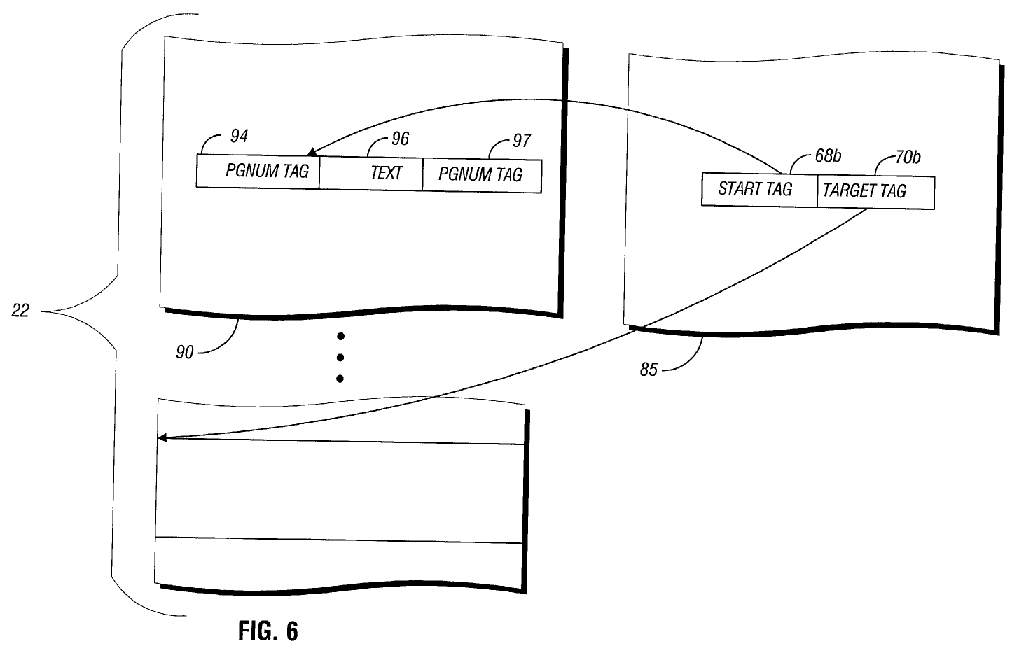

FIG. 6 illustrates the use of internal linking tags with the linking information file 20. Depicted in FIG. 6 is a portion 90 of the markup language file 22, a portion that includes beginning 94 and closing 97 page number tags (internal linking tags) that define the starting position of an internal linking operation. In this manner, when a mouse click is made on the associated tagged text 96 (i.e., a hyperlink) that is located between the tags 94 and 97, the displayed document jumps to the ending point of the linking operation, a page 98 of the document that is described by the markup language file 22.

The pair of page number tags 94 have a unique ID. For example, in some embodiments of the invention, the page number tag 94 may appear as the following: “<pgnum id=“x168”>,” and the page number tag 97 may appear as the following: “<pgnum id=“x168”/>. The character “x” denotes an internal linking tag, the characters “id=“x168”” indicate that the ID for the pair of tags 94 and 97 is “168.” Therefore, a reference to the internal linking tag ID “168” in the linking information file 20 refers to the pair of page number tags 94 and 97.

Also depicted in FIG. 6 is a portion 85 of the linking information file 20, which contains a start tag 68b and a target tag 70b. The start tag 68b identifies the pair of page number tags 94 and 97. For the example given above, the start tag 68b may indicate, for example, the page number (of the document that is described by the markup language file 22) on which the page number tag 94 is located as well as the ID (“168,” for this example) of the page number tag 94. The target tag 70b indicates the ending position of the linking operation, i.e., the page 98. Thus, to complete this example, if the page number tag 94 is located on page 8 of the document that is described by the markup language file 22, then the start tag 68b may appear as the following: “<start xlink:href=“pg8#x168”/>.” The characters “start” indicate the start tag, the character “x” indicates that the start tag 68b is associated with an internal linking tag, and the characters “pg8” and “168” indicate the page number and ID, respectively, of the pair of page number tags 94 and 97.

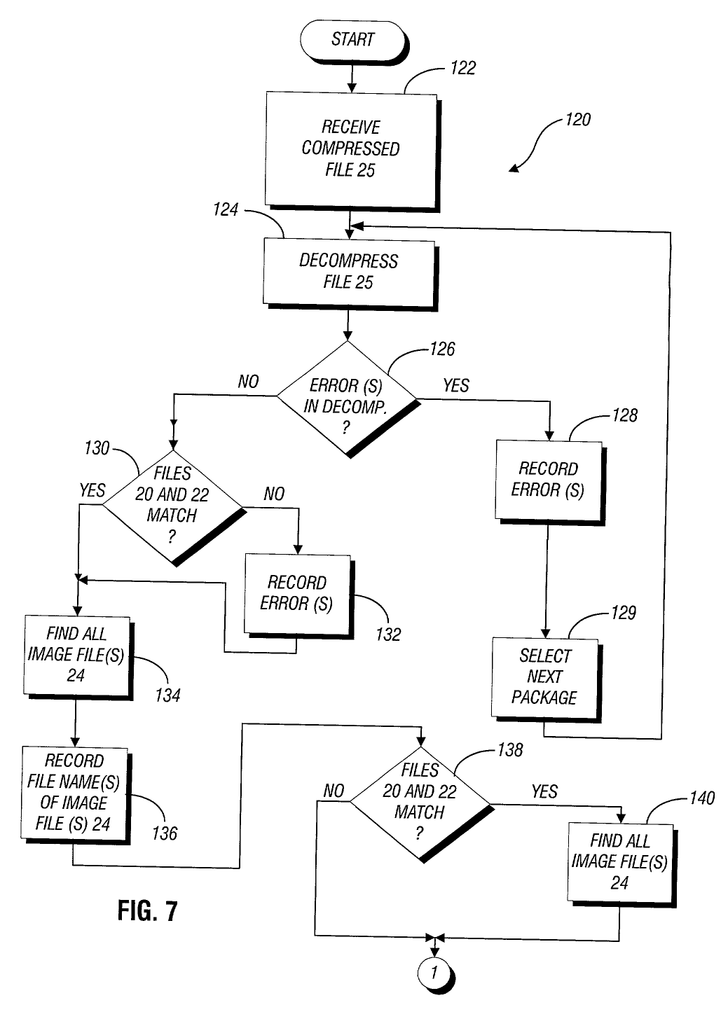

The program 36 (when executed) may cause the processor 201 to check the electronic book for errors other than tagging errors. In this manner, the program 36, in some embodiments of the invention, may cause the processor 201 to generally perform a technique 120 that is depicted in FIG. 7.

In the technique 120, the processor 201 receives (block 122) the files 25 (i.e., the files 20, 22 and 24) in a compressed format. The processor 201 decompresses (block 124) the files 25 and then determines (diamond 126) whether any errors were detected in the decompression of the files 25. If so, the processor 201 records any error(s), as depicted in block 128. If one or more errors are detected, then the processor 201 selects (block 129) the next package of files and returns to block 124 to decompress the file 25 in that other package.

Next, the processor 201 determines (diamond 130) if each markup language file 22 has a corresponding linking information file 20. In this manner, each electronic book may be described by more than one markup language file 22, and/or the technique 120 may include validating more than one book.

For simplifying the following discussion, it is assumed the files 25 consist of one markup language file 22, one corresponding linking information file 20 and one or more image files 24. However, the files 25 may include more than one markup language file 22 and more than one linking information file 20. Furthermore, it is possible that the files 25 do not contain any image files 24. In another embodiment, multiple electronic books may be incorporated in a single compressed file and each book may be decompressed individually or all books in a single compressed file may be decompressed at once.

Each markup language file 22 has the same name as the corresponding linking information file 20, except for the file name extension, an extension that denotes the file as either being a markup language file 22 or a linking information file 20. If the files 20 and 22 do not match, then the processor 201 records the error(s) (block 132).

In the next part of the technique 120, the processor 201 finds (block 134) all image file(s) 24 and records (block 136) the file name(s) of the image file(s) 24. The processor 201 may use this information later to determine if all of the image files 24 are referenced by the markup language file 22. If not, the processor 201 may record the file names of the image files 24 that were not referenced in the error record file 38. Similarly, if processor 201 detects more image files 24 than are referenced in the markup language file 22, the processor 201 may record an error in the error record file 38.

If the processor 201 determines (diamond 138) that any of the image file(s) 24 are corrupted, then the processor 201 records (block 140) any error(s). As an example of one way to check for a corrupt image file 24, the processor 201 may determine whether a particular image file 24 is corrupted by examining a size of the image file 24. In this manner, if the size of the image file 24 is zero, then the processor 201 deems that the image file 24 to be corrupted. As another example, the processor 201 may perform a checksum on a particular image file 24 to determine if the image file 24 is corrupted. Other techniques to check for corruption of the image file(s) 24 may be used.

After checking for corrupted image files and recording any detected error(s), the processor 201 subsequently begins a processing loop to build a look-up table (LUT) that contains the information for the linking operations. Thus LUT may be stored in the system memory 206 (see FIG. 2), for example.

FIG. 12 depicts an exemplary LUT 300. Other formats for the LUT may be used. The LUT 300 has two columns: a first column that contains identification fields 302 (ID₁, ID₂, . . . ID_{N}, depicted as entries in the fields 302) and a second column that contains target fields 304 (TARGET₁, TARGET₂, . . . TARGET_{N}, depicted as entries in the fields 304). Each different identification field 302 includes the identification indicated by one of the different target tags 70 of the linking information file 20 and thus, specifically identifies one of the linking tags of the markup language file 22. Each different target field 304 identifies the target of the linking operation, e.g., an image file 24 or a page of the document specified by the markup language file 22. Thus, each row of the LUT 300 indicates the beginning and end of a particular linking operation.

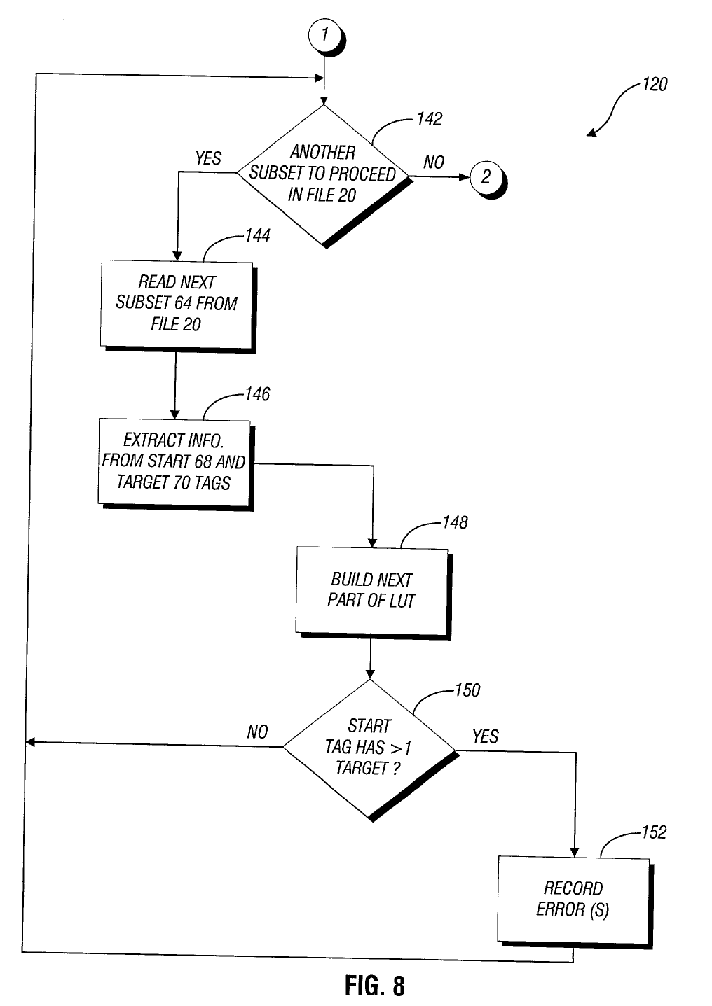

Thus, referring to FIG. 8 (and still referring to the technique 120), in this processing loop to build the LUT, the processor 201 determines (diamond 142) if another subset 64 (see FIG. 4) of the linking information file 20 exists to be processed. If so, the processor 201 reads (block 144) the next subset 64 from the linking information file 20 and extracts (block 146) the information from the start 68 and target 70 tags to build (block 148) the next part of the LUT. If during the course of building the LUT the processor 201 determines (diamond 150) that a particular linking tag has more than one target, then the processor 201 records the error 152, as depicted in block 152. Control returns to diamond 142.

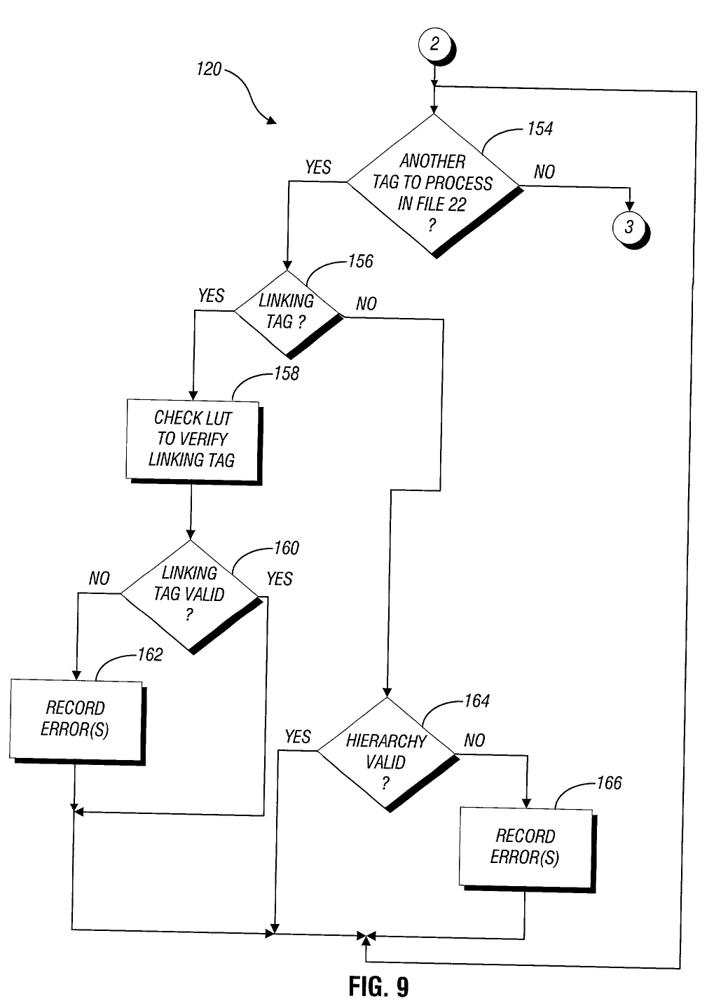

After building the LUT, the processor 201 begins a processing loop to check the tags in the markup language file 22. To perform this task, the processor 201 may use a publicly available PERL module called XML::Parser to parse the markup language file 22, in some embodiments of the invention. Referring to FIG. 9, in this processing loop, the processor 201 determines (diamond 154) whether there is another tag in the markup language file 22 to process. If so, the processor 201 determines whether this tag is a linking tag, as depicted in diamond 156. If the tag is a linking tag, then the processor 201 checks (block 158) the LUT to validate the linking tag. For example, if the linking tag is an image tag (an external linking tag), the processor 201 finds the corresponding tag (based on its ID) in the LUT and verifies that the target is an image file. If not, then the tag is invalid. As another example, if the linking tag is an internal linking tag and its target is an image file, then the tag is invalid. If the type of tag matches its target, then this is one way the processor 201 may determine that the linking tag is valid. Thus, in general, the processor 201 determines whether a particular linking tag is valid by examining the target of the tag. If the processor 201 determines (diamond 160) that the linking tag is invalid, then the processor 201 records any error(s) (block 162). After recording the error(s) (if any), control returns to diamond 154.

If the processor 201 determines (diamond 156) that the currently processed tag is not a linking tag, then the processor 201 (diamond 164) determines whether the hierarchical order of the tag is valid. In this manner, some tags, such as structural tags, are associated with a hierarchical order. For example, paragraph tags must be nested within section tags and sections tags must be nested with page tags. Many other such hierarchical relationships may exist.

For purposes of making the determination of whether a hierarchical rule is violated, the processor 201 may use flags (one for a section tag, one for a page tag, etc.) that are selectively set and cleared as the processor 201 parses the file 22 to indicate the nesting of tags. For example, when inside of a part of the file 22 that is marked by section tags, the processor 201 sets a section flag and clears the section flag when the processor 201 moves outside of this part of the file 22. If the processor 201 determines that a hierarchical rule has been violated, then the processor 201 records the error(s) 167 after processing block 166, described below

The processor 201 may valid other properties of the tag by examining (block 166) values of attributes of the tag. For example, if the tag is a section tag, the processor 201 may examine a page ID of the tag. The page ID identifies the beginning page of the section. If the processor 201 determines that the page ID is empty or otherwise invalid, the processor 201 records the error in block 167. As another example, if the processor 201 determines that the tag denotes an enumerated list, then the processor 201 examines the character that precedes each item of the list. For example, if the tag indicates a list of Roman numerals, the processor 201 determines if each item in the list is preceded by a Roman numeral. Other variations are possible. After the block 166 is processed, control passes to block 167 where the processor 201 records any error(s) before returning to diamond 154.

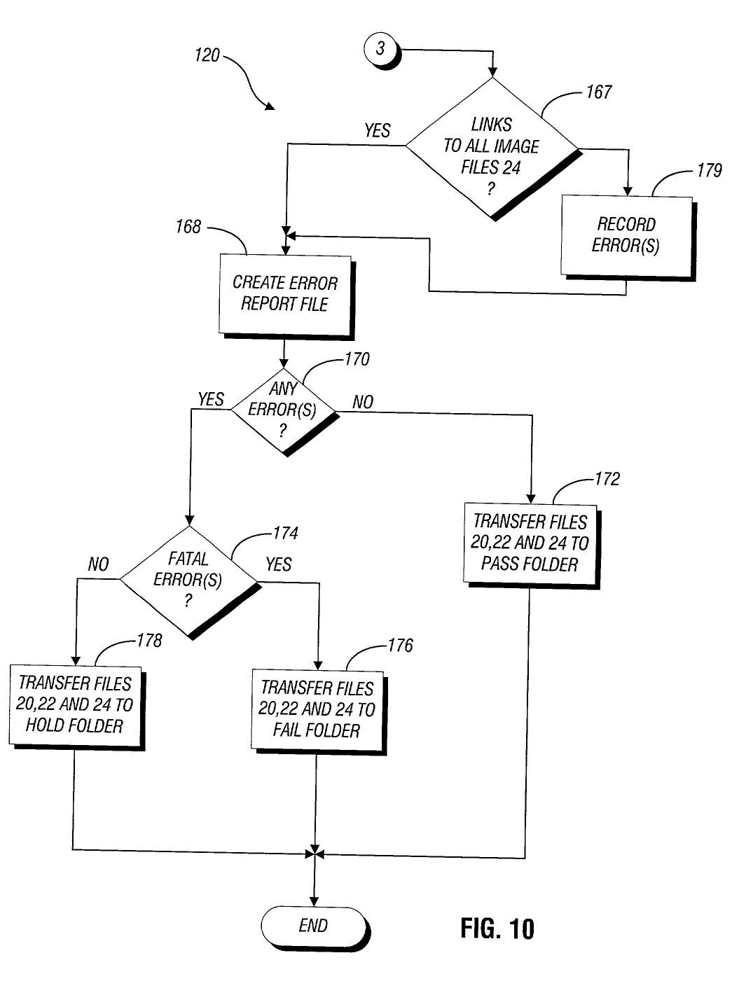

Referring to FIG. 10, after the processing of the tags in the markup language file 22, the processor 201 determines (diamond 167) whether links exist to all image files 24. If not, this indicates a possible tagging error or errors, and the processor 201 records the error(s), as depicted in block 179.

Next, the processor 201 creates (block 168) an error report file using the error record file 38 (see FIG. 2). As an example, the error report file may be a text file that is readable to form a report of the errors that were recorded when validating the electronic book. If the processor 201 determines (diamond 170) that no errors were recorded, then the processor 201 transfers the files 20, 22 and 24 to a pass folder. Otherwise, if at least one error was recorded, the processor 201 then determines if any of the error(s) were fatal, as depicted in diamond 174. A fatal error may be an error that cannot easily be corrected. For example, if an image file is corrupted or if it was determined that an image file is missing, then a corresponding fatal error is recorded. If the processor 201 determines that a fatal error was recorded, then the processor 201 transfers (block 176) the files 20, 22 and 24 to a fail folder. Otherwise, the processor 201 transfers (block 178) the files 20, 22 and 24 to a hold folder, as any recorded errors can be fixed.

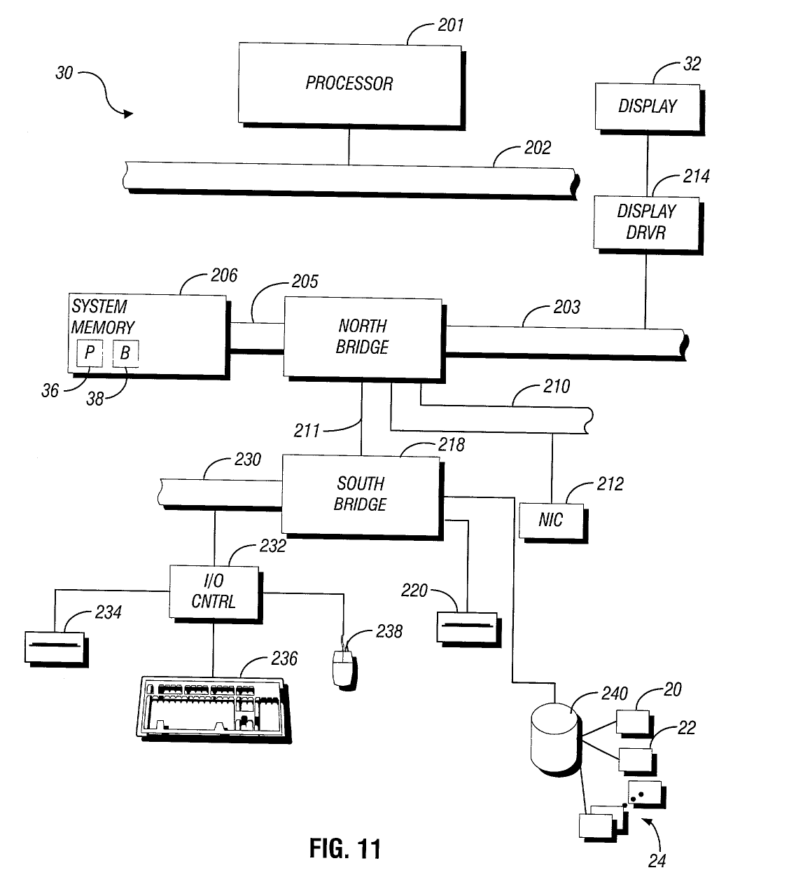

FIG. 11 depicts a more detailed schematic diagram of an exemplary embodiment of the computer system 30. Other embodiments of the computer system 30 may alternatively be used. As shown in FIG. 11, in some embodiments of the invention, the processor 201 may be coupled to a local bus 202 along with a north bridge 204. The north bridge 204 may represent a collection of semiconductor devices, or “chip set,” and provide interfaces to a Peripheral Component Interconnect (PCI) bus 210 and an AGP bus 203. The PCI Specification is available from The PCI Special Interest Group, Portland, Oreg. 97214. The AGP is described in detail in the Accelerated Graphics Port Interface Specification, Revision 1.0, published on Jul. 31, 1996, by Intel Corporation of Santa Clara, Calif.

A display driver 214 may be coupled to the AGP bus 203 and provide signals to drive a display 216. The PCI bus 210 may be coupled to a network interface card (NIC) 212 that provides a communication interface for the computer system 30 to a network. The north bridge 204 may also include a memory controller to communicate data over a memory bus 205 with the system memory 206. As an example, the system memory 206 may store all or a portion of program instructions associated with the program 36 and store the error record file 38. The memory 206 may also store parts of the files 20, 22 and 24 that are currently being processed. In some embodiments of the invention, some of the above-described software may be executed on or stored on another computer system that is coupled to the computer system 10 via a network through the NIC 212.

The north bridge 204 communicates with a south bridge 218 via a hub link 211. The south bridge 218 may represent a collection of semiconductor devices, or “chip set,” and provide interfaces for a hard disk drive 240, a CD-ROM drive 220 and an I/O expansion bus 230, as just a few examples. The hard disk drive 240 may store all or portions of the files 20, 22 and 24 as well as all or a portion of the instructions of the program 38, in some embodiments of the invention.

An I/O controller 232 may be coupled to the I/O expansion bus 230 to receive input data from a mouse 238 and a keyboard 236. The I/O controller 232 may also control operations of a floppy disk drive 234.

Other embodiments are within the scope of the following claims. For example, an external linking tag may have a target other than an image file, such as a file indicative of an audio clip, a video clip, a journal, a newspaper, another book or some combination of these items, as just a few examples.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
finding a tag in a markup language file; and
automatically locating a target of the tag; and
automatically determining whether the tag is valid based on the target.

2. The method of claim 1, wherein the locating the target comprises finding the target in another file.

3. The method of claim 2, wherein said another file comprises a linking information file.

4. The method of claim 1, wherein the determining comprises:
determining whether the tag comprises an external linking tag; and
if the tag comprises an external linking tag, verifying that the target indicates a file name that is consistent with the external linking tag.

5. The method of claim 1, wherein the verifying comprises:
determining if a type of the tag matches a type of the target.

6. The method of claim 1, wherein the target comprises a file indicative of at least one of an image, a book, a newspaper article, journal article, an audio clip and a video clip.

7. The method of claim 1, wherein the determining comprises:
determining whether the tag comprises an internal linking tag; and
if the tag is an internal linking tag, verifying that the target points to a place inside the markup language file.

8. The method of claim 1, wherein the finding comprises:
scanning the markup language file to locate linking tags.

9. The method of claim 1, further comprising:
storing an indication of the result of the determination in an error record file if the tag is invalid.

10. A method comprising:
finding linking tags in a markup language file, each tag associated with a target;
automatically locating the targets; and
automatically selectively determining whether the tags are valid based on the targets.

11. The method of claim 10, wherein the locating the targets comprises finding the targets in another file.

12. The method of claim 11, wherein said another file comprises a linking information file.

13. The method of claim 10, wherein
each tag is associated with an identifier, and
the act of selectively determining whether the tags are valid comprises determining if more than one of the identifiers are associated with the same target.

14. The method of claim 10, wherein the determining comprises:
determining a type of the tag; and
further basing the determination of whether the tag is valid based on the type of the tag.

15. The method of claim 10, wherein the determining comprises:
determining whether the tag comprises an internal linking tag; and
if the tag comprises an internal linking tag, verifying that the target points to a place inside the document.

16. The method of claim 10, wherein the verifying comprises:
determining if a type of the tag matches a type of the target.

17. The method of claim 10, wherein the target comprises a file indicative of at least one of an image, a book, a newspaper article, journal article, an audio clip and a video clip.

18. A method comprising:
providing a markup language file that is associated with a book and image files that are associated with an electronic book;
automatically scanning the markup language file to find links between the markup language file and the image files; and
determining whether errors exist based on the scanning.

19. The method of claim 18, wherein the determining comprises:
determining whether no links exist between at least one of the image files and the markup language file.

20. The method of claim 19, further comprising:
storing an indication of the result of the determination in an error file if no link exists between one of the image files and the markup language file.

21. An article comprising a computer readable storage medium storing instructions to cause a computer to:
find a tag in a markup language file; and
locate a target of the tag; and
determine whether the tag is valid based on the target.

22. The article of claim 21, the storage medium storing instructions to cause the computer to:
find the target in another file.

23. The article of claim 22, wherein said another file comprises a linking information file.

24. The article of claim 21, the storage medium storing instructions to cause the computer to:
determine whether the tag comprises an image tag; and
if the tag comprises an image tag, verify that the target comprises an image file.

25. The article of claim 21, the storage medium storing instructions to cause the computer to:
determine whether the tag comprises an internal linking tag; and
if the tag comprises an internal linking tag, verify that the target points to a place inside the markup language file.

26. The article of claim 21, the storage medium storing instructions to cause the computer to:
scan the markup language file to locate linking tags.

27. The article of claim 21, the storage medium storing instructions to cause the computer to:
store an indication of the result of the determination in an error file if the tag is invalid.

28. The article of claim 21, the storage medium storing instructions to cause the computer to:
determine if a type of the tag matches a type of the target.

29. The article of claim 21, wherein the target comprises a file indicative of at least one of an image, a book, a newspaper article, journal article, an audio clip and a video clip.

30. An article comprising a computer readable storage medium storing instructions to cause a computer to:
find linking tags in a markup language file, each tag associated with a target;
locate the targets; and
selectively determine whether the tags are valid based on the targets.

31. The article of claim 30, the storage medium storing instructions to cause the computer to:
locate the target by scanning another file.

32. The article of claim 31, wherein said another file comprises a linking information file.

33. The article of claim 30, wherein
each tag is associated with an identifier, and
the storage medium stores instructions to cause the computer to determine if more than one of the identifiers are associated with the same target.

34. The article of claim 30, the storage medium storing instructions to cause the computer to:
determine a type of the tag; and
further base the determination of whether the tag is valid based on the type of the tag.

35. The article of claim 30, the storage medium storing instructions to cause the computer to:
determine whether the tag comprises an internal linking tag; and
if the tag comprises an internal linking tag, verify that the target points to a place inside the markup language file.

36. The article of claim 30, the storage medium storing instructions to cause the computer to:
determine if a type of the tag matches a type of the target.

37. The article of claim 30, wherein the target comprises a file indicative of at least one of an image, a book, a newspaper article, journal article, an audio clip and a video clip.

38. An article comprising a computer readable storage medium storing instructions to cause a computer to:
receive a markup language file that is associated with a book and image files that are associated with an electronic book;
automatically scan the markup language to find links between the markup language file and the image files; and
determine whether tagging errors exist based on the scan.

39. The article of claim 38, the storage medium storing instructions to cause the computer to:
determine whether no links exist between at least one of the image files and the markup language file.

40. The article of claim 38, the storage medium storing instructions to cause the computer to:
store an indication of the result of the determination in an error file if no link exists between one of the image files and the markup language file.

41. A computer system comprising:
a memory storing a program; and
a processor to execute the program to cause the processor to:
find a tag in a markup language file;
locate a target of the tag; and
determine whether the tag is valid based on the target.

42. The computer system of claim 41, the processor adapted to scan another file to locate the target.

43. The computer system of claim 41, wherein said another file comprises a linking information file.

44. The computer system of claim 41, the program comprising instructions to cause the processor to:
determine whether the tag comprises an image tag; and
if the tag comprises an image tag, verify that the target comprises an image file.

45. The computer system of claim 41, the program comprising instructions to cause the processor to:
determine whether the tag comprises an internal linking tag; and
if the tag comprises an internal linking tag, verify that the target points to a place inside the markup language file.

46. The computer system of claim 41, the program comprising instructions to cause the processor to:
scan the markup language file to locate linking tags.

47. The computer system of claim 41, the program comprising instructions to cause the processor to:
store an indication of the result of the determination in an error file if the tag is invalid.

48. The computer system of claim 33, the storage medium storing instructions to cause the computer to:
determining if a type of the tag matches a type of the target.

49. The computer system of claim 33, wherein the target comprises indicative of at least one of an image, a book, a newspaper article, journal article, an audio clip and a video clip.

50. A computer system comprising:
a memory to store a program; and
a processor to execute the program to cause the processor to:
find linking tags in a markup language file, each tag associated with a target;
locate the targets; and
selectively determine whether the tags are valid based on the targets.

51. The computer system of claim 50, the processor adapted to scan another file to find the targets.

52. The computer system of claim 50, wherein said another file comprises a linking information file.

53. The computer system of claim 50, wherein
each tag is associated with an identifier, and
the program comprises instructions to cause the processor to determine if more than one of the identifiers are associated with the same target.

54. The computer system of claim 50, the program comprising instructions to cause the processor to:
determine a type of the tag; and
further base the determination of whether the tag is valid based on the type of the tag.

55. The computer system of claim 50, the program comprising instructions to cause the processor to:
determine whether the tag comprises an internal linking tag; and
if the tag comprises an internal linking tag, verify that the target points to a place inside the markup language file.

56. The computer system of claim 50, the program comprising instructions to cause the processor to:
determine if a type of the tag matches a type of the target.

57. The computer system of claim 50, wherein the target comprises a file indicative of at least one of an image, a book, a newspaper article, journal article, an audio clip and a video clip.

58. A computer system comprising:
a memory storing a program; and
a processor to execute the program to:
provide a markup language file that is associated with a book and image files that are associated with an electronic book;
scan the document to find links between the markup language file and the image files; and
determine whether tagging errors exist in the book based on the scanning.

59. The computer system of claim 58, the program comprising instructions to cause the processor to:
determine whether no links exist between at least one of the image files and the markup language file.

60. The computer system of claim 58, the program comprising instructions to cause the processor to:
store an indication of the result of the determination in an error file if no links exist between the image files and the markup language file.
